(19) United States
(12) Patent Application Publication
(10) Pub. No.: US 2013/0315579 A1
(43) Pub. Date: Nov. 28, 2013

(54) METHOD AND SYSTEM FOR PROVIDING A SHARED DEMARCATION POINT TO MONITOR NETWORK PERFORMANCE

(71) Applicants: Tiejun J. XIA, Richardson, TX (US); Glenn A. WELLBROCK, Basking Ridge, NJ (US)

(72) Inventors: Tiejun J. XIA, Richardson, TX (US); Glenn A. WELLBROCK, Basking Ridge, NJ (US)

(73) Assignee: Verizon Patent and Licensing Inc., Basking Ridge, NJ (US)

(21) Appl. No.: 13/480,571

(22) Filed: May 25, 2012

(51) Int. Cl. H04B 10/08; H04B 10/00

(52) U.S. Cl. 398/5

(57) ABSTRACT

An approach for detecting an error associated with a routing network coupled to a transport network comprising a plurality of optical communication nodes, switching, by an optical communication node, to a troubleshooting channel associated with the transport network using one or more router counterpart cards, and troubleshooting the error using the one or more router counterpart cards.

### BACKGROUND INFORMATION

In general, connectivity between a routing network and an optical transport network is provided in one of two ways. Under a first approach, short-reach optics are used to connect a router port at a user (or client) side of a transponder to the client side router. Long-reach optics are then used to connect the transport network to the line side of the transponder. Under this approach, the transponder provides a clear demarcation point for a service provider to troubleshoot errors and/or network performance issues. However, short-reach optics are more expensive than long-reach optics, especially at higher transport speeds. Accordingly, a second approach has been developed that uses long-reach optics to connect the router port at the client side directly to the transport network. Because the second approach does not use short-reach optics, the cost associated with the second approach is less than the first approach. However, the second approach may not have a clear demarcation point between the client signal and the network signal because compatibility issues associated with the equipment of the routing network and transport network. Without a clear demarcation point, network troubleshooting becomes problematic.

Based on the foregoing, there is a need for a shared demarcation point associated with transport networks connected to routing networks.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing a shared demarcation point, according to one embodiment;

FIGS. 2A-2G are diagrams of a transport network between two routing networks capable of providing a shared demarcation point, according to various exemplary embodiments;

FIGS. 3A and 3B are diagrams of router counterpart cards capable of providing a shared demarcation point within a transport network, according to various embodiments;

FIG. 4 is a flowchart of troubleshooting an error associated with a connection between a routing network and a transport network, according to one embodiment;

FIG. 5 is a flowchart of troubleshooting an error between a routing network and a router counterpart card, according to one embodiment;

FIG. 6 is a flowchart of troubleshooting an error between two router counterpart cards within a transport network, according to one embodiment;

FIG. 7 is a diagram of a ROADM configured to perform a loop-back function, according to one embodiment;

FIG. 8 is a flowchart of a process for troubleshooting an optical network with ROADM, according to one embodiment;

FIG. 9 is a diagram of a ROADM configured to check and isolate problems towards network equipment with loop-back ports located on the add/drop module, according to one embodiment;

FIG. 10 is a diagram of a ROADM configured to check and isolate problems towards network equipment with loop-back ports located on the switching module, according to one embodiment;

FIG. 11 is a diagram of a ROADM configured to check and isolate problems towards customer equipment with loop-back ports located on the add/drop module, according to one embodiment;

FIG. 12 is a diagram of a ROADM configured to check and isolate problems towards customer equipment with loop-back ports located on the add/drop module, according to one embodiment;

FIG. 13 is a diagram of a ROADM configured to check and isolate problems towards customer equipment with loop-back ports located on the add/drop module, according to one embodiment;

FIG. 14 is a diagram of a computer system that can be used to implement aspects of the processes associated with FIGS. 4-6 and 8, according to one embodiment; and

FIG. 15 is a diagram of a chip set that can be used to implement aspects of the processes associated with FIGS. 4-6 and 8, according to one embodiment.

### DESCRIPTION OF THE PREFERRED EMBODIMENT

An apparatus, method, and software for providing a shared demarcation point, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

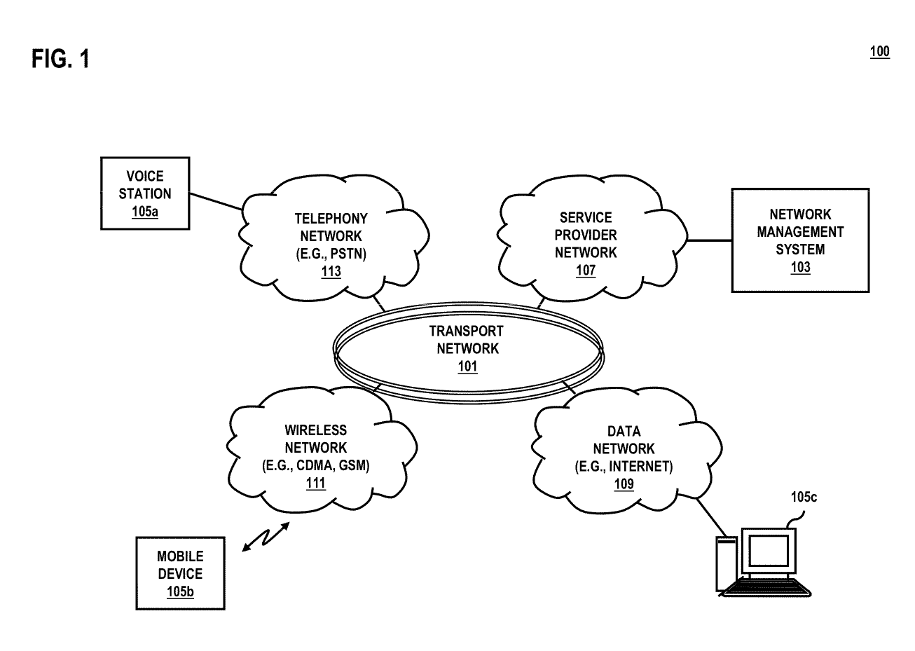

FIG. 1 is a diagram of a system 100 capable of providing a shared demarcation point within a transport network connected to a routing network using long-reach optics, according to one embodiment. As discussed above, there are generally two approaches for sending router traffic from end to end in a fiber optic transport network. The first approach uses short-reach optics to connect a router port at the user (e.g., client or subscriber) side of a transponder and long-reach optics at the network side of the transponder. The long-reach optics then send out signals across the fiber optic transport network. The second approach uses long-reach optics directly from the router to the fiber optic transport network. Although the second approach is less expensive than the first approach because of the lack of short-reach optics, particularly at higher network speeds, the second approach has no clear demarcation between the client signal and the network signal because the router and the transport network equipment are usually not manufactured by the same vendor.

Thus, the approach of the system 100 stems, in part, from the recognition that there is no clear demarcation point for the user signal at a routing network and the network signal at the transport network in a fiber optic network that uses long-reach optics for connectivity.

As shown in FIG. 1, the system 100 may include a network management system 103 implemented as, for example, part of a service provider network 107, according to one embodiment. In alternative embodiments, the network management system 103 may be implemented as any part of the system 100. The network management system 103 allows for management of the service provider network 107 and a transport network 101. According to certain embodiments, the transport network 101 provides a transport network for various end user devices 105a-105c (e.g., voice station 105a, mobile device 105b, computing device 105c, etc.) to communicate. The network 101 can interconnect one or more networks, such as service provider network 107, data network 109, wireless network 111, and/or telephony network 113. The transport network 101, in one embodiment, may be a part of the service provider network 107 in providing a backbone network for the various networks 109-113.

For illustrative purposes, the networks 107-113 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 109 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 107 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, networks 107-113 may embody or include portions of a signaling system 7 (SS7) network, or other suitable infrastructure to support control and signaling functions.

According to exemplary embodiments, end user devices 105 may include any customer premise equipment (CPE) capable of sending and/or receiving information over one or more of networks 107-113. For instance, voice station 105a may be any suitable plain old telephone service (POTS) device, facsimile machine, etc., whereas mobile device (or terminal) 105b may be any cellular phone, radiophone, satellite phone, smart phone, wireless phone, or any other suitable mobile device, such as a personal digital assistant (PDA), pocket personal computer, tablet, customized hardware, etc. Further, computing device 105c may be any suitable computing device, such as a VoIP phone, skinny client control protocol (SCCP) phone, session initiation protocol (SIP) phone, IP phone, personal computer, softphone, workstation, terminal, server, etc.

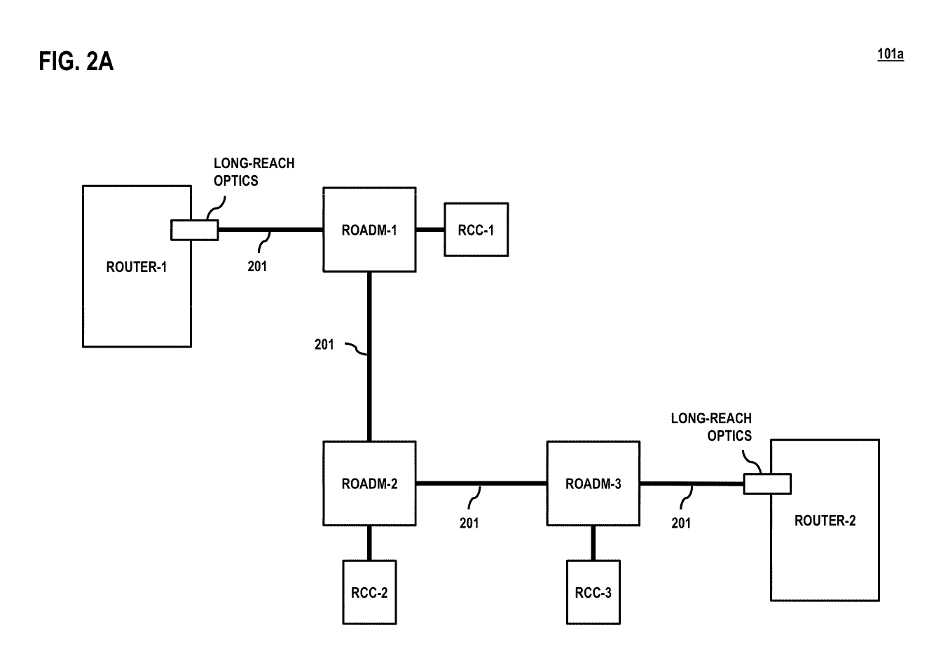

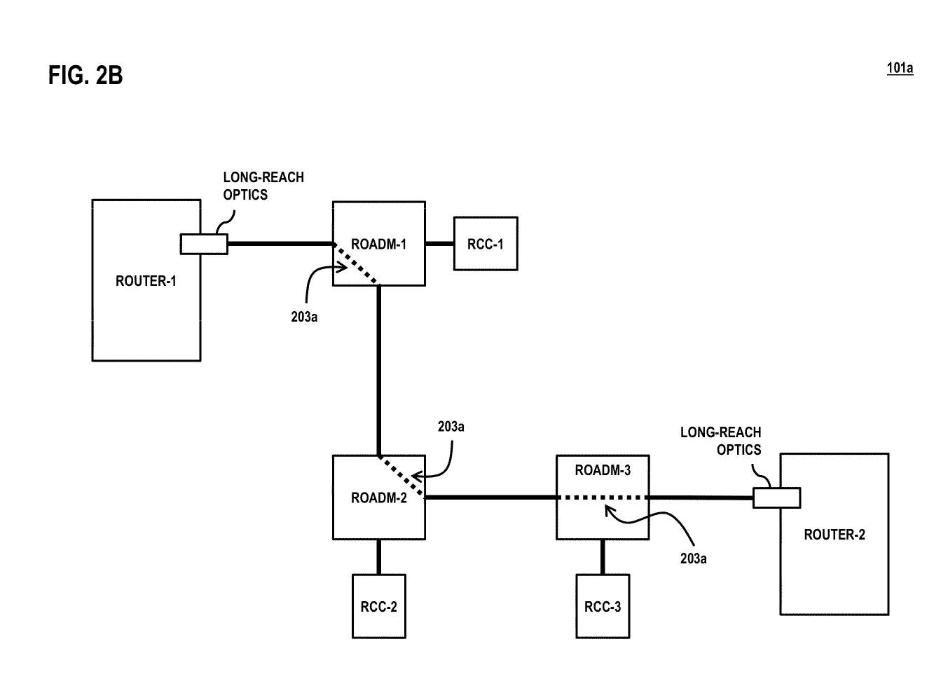

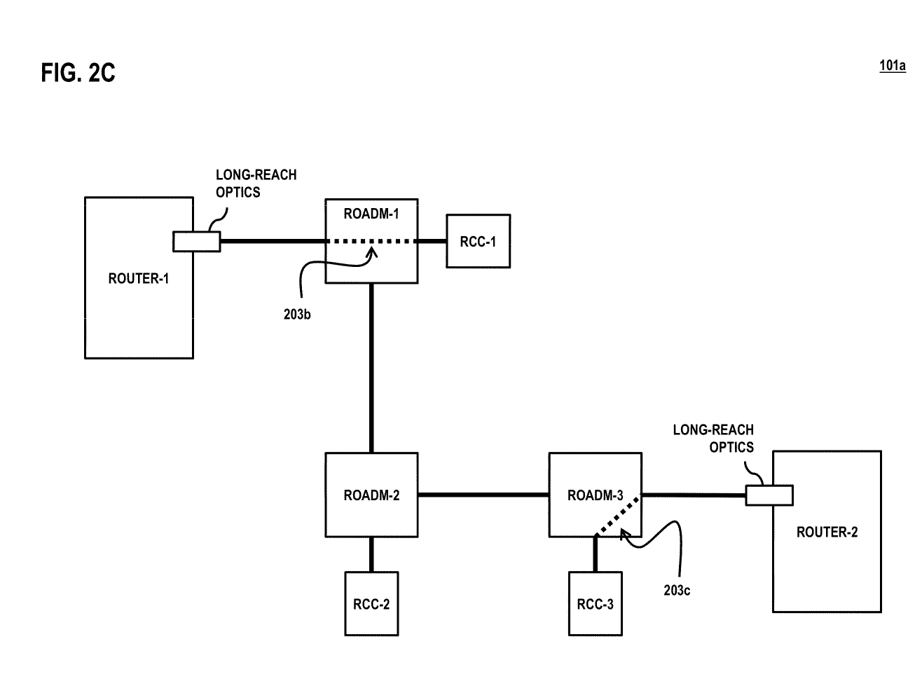

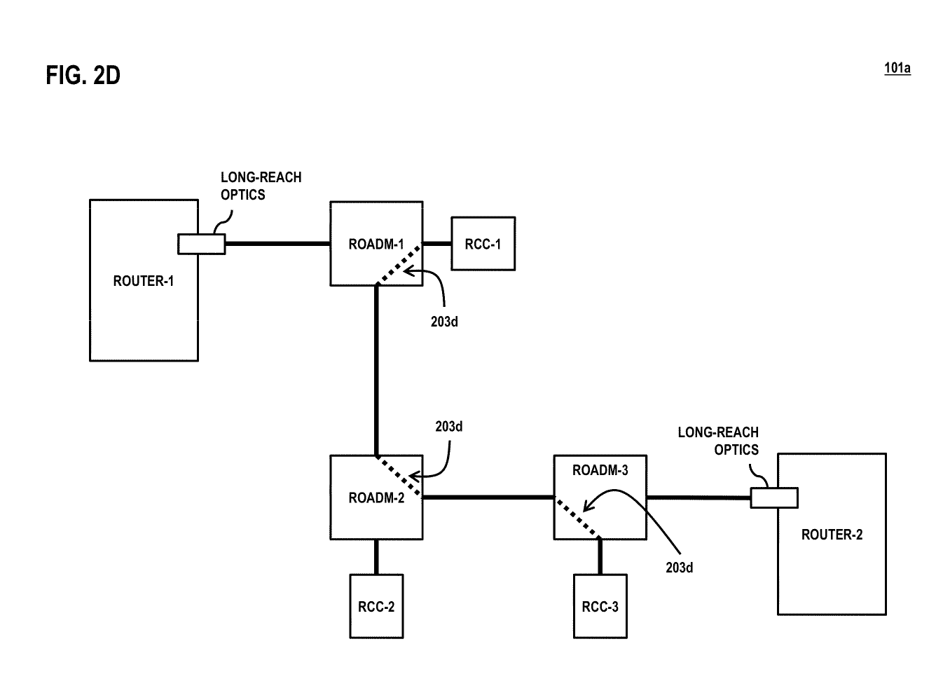

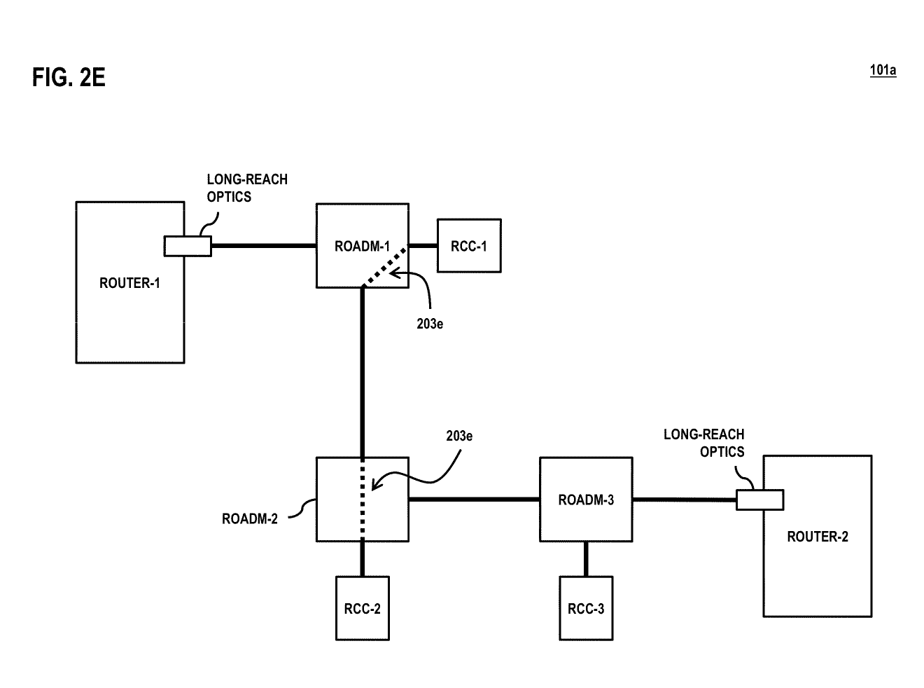

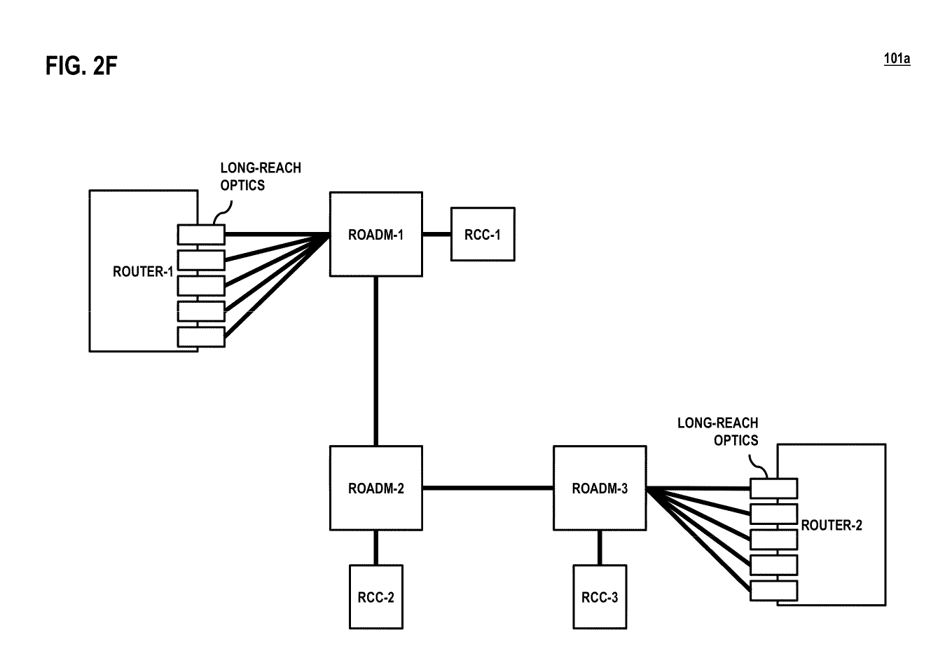

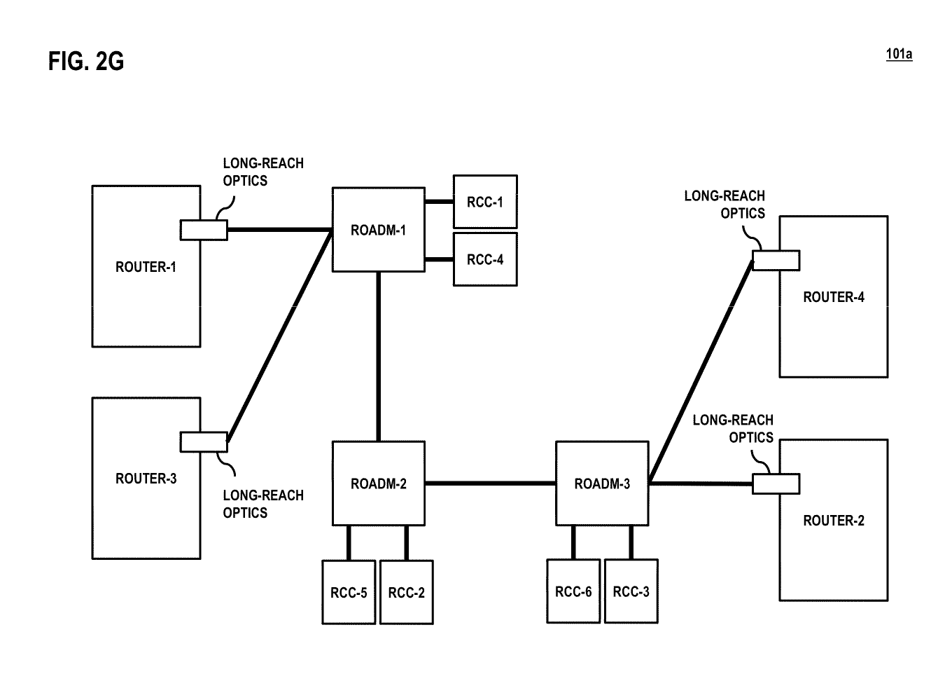

FIGS. 2A-2G are diagrams of a section 101a of the transport network 101 between two routers (e.g., router-1 and router-2) capable of providing a shared demarcation point, according to various exemplary embodiments. As illustrated in FIG. 2A, the section 101a of the transport network 101 includes two endpoint routers router-1 and router-2. The two routers may be geographically separated by large distances depending on the needs of the service provider associated with the transport network 101. Accordingly, errors that occur associated with the routing network and the transport network may be caused by similarly geographically separated network faults. The geographical separation increases the need for the ability to accurately determine where within the transport network 101 the fault is occurring causing the error.

As illustrated, each router is connected to the section 101a of the transport network 101 using long-reach optics. The section 101a of the transport network 101 may be a fiber-optic network including a plurality of optical communication nodes. In one embodiment, the optical communications nodes may include reconfigurable optical add/drop modules (ROADM). As illustrated, the section 101a of the transport network 101 includes three ROADMs: ROADM-1, ROADM-2 and ROADM-3. However, the section 101a of the transport network 101a may include any number of ROADMs. The routers and ROADMs are connected via one or more fibers 201 that make up the section 101a of the fiber optic transport network 101.

As further illustrated, each of the ROADMs include a router counterpart card (RCC) (e.g., RCC-1, RCC-2, and RCC-3). The RCCs provide the ability to have a shared demarcation point within the transport network 101 despite, for example, not having transponders connecting the routers to the transport network 101. The RCCs may act as a shared demarcation point within the transport network that provide for troubleshooting channels within the transport network to determine the location and/or reason for one or more errors within a transport network. In one embodiment, the RCCs may be simplified versions (e.g., reduced and/or specialized functionality) of the routers such that they have similar transmission and reception capabilities as the routers at a reduced cost of manufacturing. Although FIG. 2A illustrates that each ROADM is associated with a separate RCC, in one embodiment, only the endpoint ROADMs may include RCCs. Further, in various other embodiments, any number of ROADMs may be associated with RCCs.

In one embodiment, the ROADM may include one or more loop-back connections to enable a loop-back functionality within the ROADM, in part, by selectively switching signals to the one or more loop back connections. In one embodiment, the network management system 103 controls how the ROADM selectively switches signals to check network performance. Under this approach, the one or more loop-back connections within the ROADM also may troubleshoot connections within the transport network 101. In one embodiment, every ROADM within the transport network 101 may include one or more loop-back connections. In one embodiment, the ROADMs that are not at the egress and ingress of the transport network include the loop-back connections. In one embodiment, one or more ROADMs may include router counterpart cards and one or more loop-back connections. However, in one embodiment, ROADMs may include either router counterpart cards or one or more loop-back connections, such as where the egress and ingress ROADMs include router counterpart cards and the other ROADMs within the transport network 101 include one or more loop-back connections. The inclusion of loop-back connections within the ROADMs introduces the capability to perform loop-back functionality, in combination with error testing associated which may reduce troubleshoot time by utilizing the one or more loop back-connections.

FIG. 2B illustrates the section 101a of the transport network 101 under normal operations. For example, a light path 203a may be established between router-1 and router-2 across the section 101a of the transport network 101. The ROADMs may switch the light path 203a along the section 101a of the transport network 101a to establish the path between the routers. When an error occurs such that the light path 203a becomes broken, there was previously no way to determine where within the section of the transport network 101a the error occurred for transport networks that are directly connected to routing networks using long-reach optics. However, the addition of the RCCs provides the ability to have a shared demarcation point within the section 101a of the transport network 101 that allows for the determination of where within the transport network 101 the error causing the breakage of the light path 203a occurred.

For example, FIG. 2C illustrates the ability to troubleshoot the connection of the transport network 101 with a routing network between the routers and the ROADMs at the ingress and the egress points of the transport network 101. For example, the ROADM-1 (e.g., at the ingress point) may switch to a port associated with a troubleshooting channel that is established with the RCC-1. In one embodiment, the ROADM-1 may switch to the troubleshooting channel in response to one or more commands and/or signals from the network management system 103. However, in one embodiment, the ROADM-1 may switch to the troubleshooting channel based on one or more commands and/or signals from the router-1. In one embodiment, the RCC-1 may then generate a test signal 203b that is sent to the router-1. The RCC-1 may be controlled by the network management system 103, by the router-1, or a combination thereof. In one embodiment, the router-1 may generate the test signal 203b that is then sent to the RCC-1. Under either embodiment, the network management system 103 may then determine whether there is an error between the RCC-1 and the router-1 based on whether the test signal 203b is successfully transmitted between the router-1 and the RCC-1. The same approach may be performed with the router-2 and the ROADM-3 (e.g., at the egress point) using the RCC-3 to generate a test signal 203c to determine if the location of the cause of the error between the ROADM-3 and the router-2. Accordingly, the RCC-1 and the RCC-3 provide for shared demarcation points that allow for the troubleshooting of errors associated with the transport network 101.

FIG. 2D illustrates the ability to troubleshoot the entire section 101a of the transport network 101 excluding the section at the ingress and the egress. For example, the ROADM-1 may represent the first optical communication node on the transport network 101. The ROADM-1 may switch to a port associated with a troubleshooting channel associated with the RCC-1 that allows for the transmission of a test signal over the transport network 101 towards the other end of the transport network 101 at ROADM-3, which represents the last optical communication node on the transport network 101. The RCC-1 (e.g., first RCC along the transport network 101) may then generate and transmit a test signal 203d to the RCC-3 (e.g., last RCC along the transport network 101). The network management system 103 may detect whether the RCC-3 receives the test signal 203d to determine if the error is somewhere between the RCC-1 (e.g., the ROADM-1, the first optical communication node of the transport network 101) and the RCC-3 (e.g., ROADM-3, the last optical communication node of the transport network 101).

Further, FIG. 2E illustrates the ability to troubleshoot the section 101a of the transport network 101 using the same principles as discussed with respect to FIGS. 2C and 2D. Specifically, the troubleshooting of the section 101a of the transport network 101 between the ROADM-1 and the ROADM-2 may be performed by generating a test signal 203e with the RCC-1 and transmitting the test signal 203e to the RCC-2. The network management system 103 may detect whether the RCC-2 receives the test signal 203e to determine if the error is somewhere between the RCC-1 and the RCC-2. The same procedure may be performed between any two RCCs (e.g., between any two ROADMs). In one embodiment, the two RCCs may be associated with two ROADMs that are in optical sequence along the transport network 101.

In one embodiment, the routers router-1 and router-2 may have multiple connections to the transport network 101 at the ingress and egress ROADMs. As illustrated in FIG. 2F, there may be five connections between the router-1 and the ROADM-1 and between the router-2 and the ROADM-3. All of the connections between the routers and the ROADMs may be serviced by the same RCCs associated with the ROADMs.

In one embodiment, there may be more than one router connected to the transport network 101 at the ingress and egress points. For example, router-1 and router-3 may be connected to the ROADM-1 at the ingress point of the transport network 101 and router-2 and router-4 may be connected to the ROADM-3 at the egress point. Additionally, router-1 and router-2 may be of one type (e.g., brand/manufacturer) and router-3 and router-4 may be of another type (e.g., brand/manufacturer). Accordingly, the transport network 101 may include multiple RCCs at the ROADMs that are compatible with the various types of the routers. For instance, RCC-1, RCC-2 and RCC-3 may be compatible with router-1 and router-2, while RCC-4, RCC-5 and RCC-6 may be compatible with router-3 and router-4.

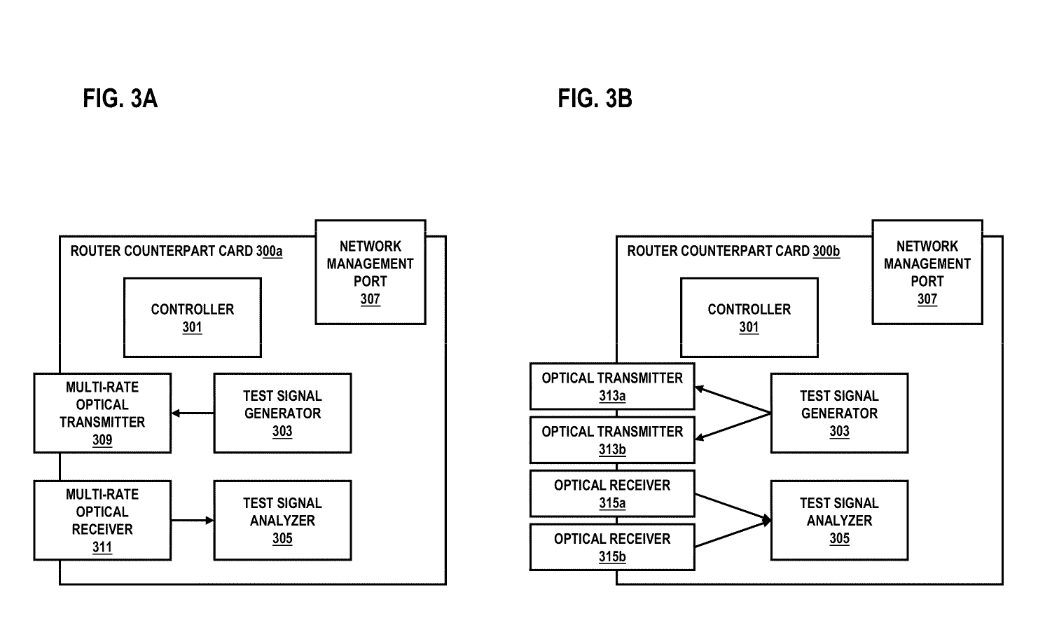

FIGS. 3A and 3B are diagrams of RCCs 300a and 300b capable of providing a shared demarcation point, according to various exemplary embodiments. As illustrated in FIGS. 3A and 3B, the RCC may include a controller 301, a test signal generator 303, a test signal analyzer 305 and a network management port 307. The controller 301 may execute one or more functions and/or one or more algorithms based on one or more instructions, such as one or more computer program instructions, to perform the processes described herein for providing a shared demarcation point. The test signal analyzer 303 and the test signal generator 305 may generate and receive, respectively, the test signals that are used to troubleshoot errors associated with the transport network 101. The network management port 307 may provide a connection for the RCCs to the network management system 103 for the network management system 103 to control the RCCs and receive the troubleshooting information.

In one embodiment, as illustrated in FIG. 3A, the RCCs 300a may include a multi-rate optical transmitter 309 and a multi-rate optical receiver 311. The multi-rate optical transmitter 309 and the multi-rate optical receiver 311 allow the RCCs to communicate with the routers, ROADMs and other RCCs at various different rates using the same transmitter and receiver. In one embodiment, as illustrated in FIG. 3B, the RCCs 300b may include multiple optical transmitters 313a and 313b and multiple optical receivers 315a and 315b. The multiple optical transmitters 313a and 313b and the multiple optical receivers 315a and 315b allow the RCCs to communicate with the routers, ROADMs and other RCCs at various different rates using different transmitters and receivers. Whether the RCCs 300a or the RCCs 300b or both are used in the transport network 101 may be determined based on compatibilities of the transport network 101 for multi-rate transmitters and receivers, which may be determined based on, for example, compatibility issues associated with the routers. By way of example, the rates associated with the transmitters and receivers may be, for example, 10 GE, 40 GE and/or 100 GE.

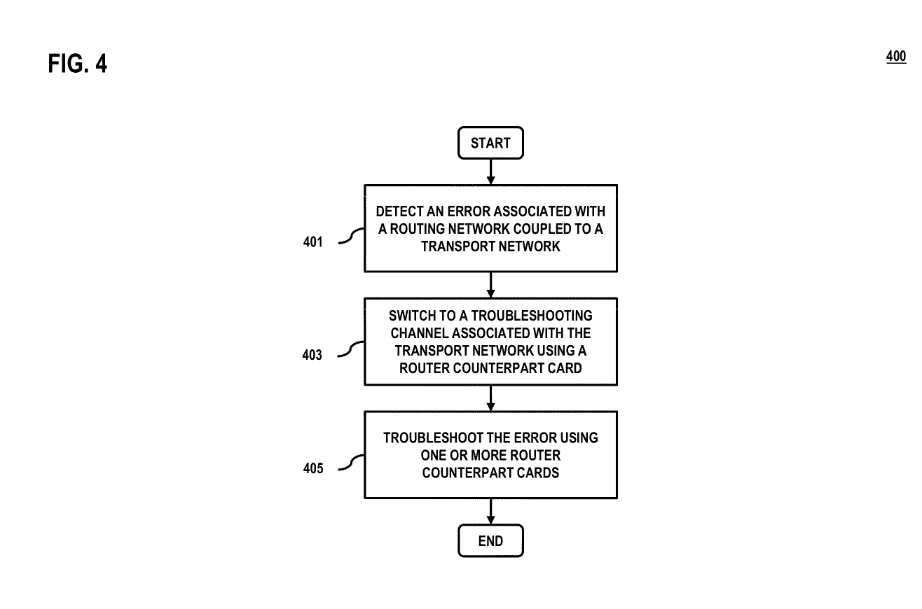

FIG. 4 is a flowchart of troubleshooting an error associated with a connection between a routing network and a transport network, according to one embodiment. In one embodiment, one or more router counterpart cards as illustrated in FIG. 3A or 3B may perform the process 200 in association with other elements of the transport network and/or the routing network. In step 401, an error associated with a routing network coupled to a transport network is detected. The transport network may include a plurality of optical communication nodes. One or more of the optical communication nodes may be ROADMs. The transport network may provide a communication network between two routing networks. The error may be detected by a network management system 103 based on, for example, two endpoint routers being unable to communicate with each other and therefore generating a circuit complaint that is sent to the network management system 103. The network management system 103 may then begin troubleshooting associated with the complaint.

In step 403, the network management system 103 may begin troubleshooting the complaint by switching to a troubleshooting channel associated with the transport network using one or more router counterpart cards. The network management system 103 may request that one or more of the routers on either end of the transport network release the circuit. The network management system 103 may then request that the routers switch to router ports associated with various router counterpart cards. The troubleshooting channel may be established based on at least one router counterpart card that is associated with an optical communication node within the transport network, such as associated with a ROADM.

In step 405, the router counterpart cards and/or the routers may troubleshoot the error by sending test signals between each other. The test signals may be generated based on any one of the embodiments discussed above with respect to FIGS. 2B-2E, such as between an ingress router counterpart card and a router of the routing network, between ingress and egress router counterpart cards associated with the transport network, two router counterpart cards within the transport network that are not necessarily at the ingress and egress positions, including two sequential router counterpart cards, and the like. The cause of the error may be detected based on the inability for a test signal to reach another element within the transport network and/or between the transport network and the routing network. Based on the troubleshooting that occurs, that network management system 103 may determine where within the transport network or the connections between the transport network and the routing network the error occurred to determine the appropriate response to correct the error, such as dispatching a crew to the location associated with the error. Once the error is corrected, the routers and ROADMs may release the troubleshooting channel and resume previous operations.

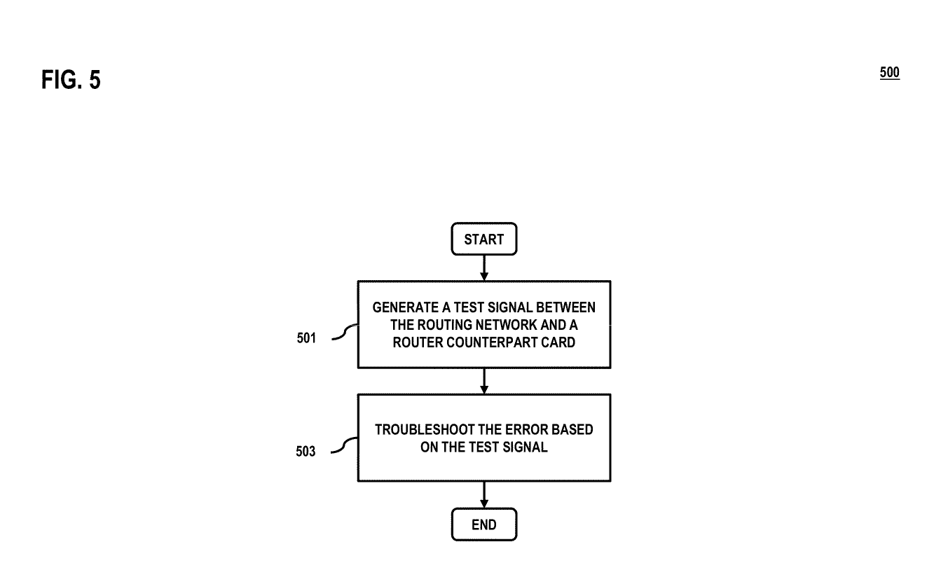

FIG. 5 is a flowchart of troubleshooting an error between a routing network and a router counterpart card, such as at the egress and/or ingress points of the transport network, according to one embodiment. In one embodiment, one or more router counterpart cards as illustrated in FIG. 3A or 3B may perform the process 500 in association with other elements of the routing network. In step 501, a test signal is generated between the routing network and a router counterpart card. The test signal may be generated by a router within the routing network, the router counterpart card, or both. By way of example, a router that is in communication with the transport network may transmit a test signal to an endpoint router counterpart card associated with the transport network. Further, the endpoint router counterpart card may transmit a test signal to the endpoint router of the routing network. Prior to generating a test signal, the router within the routing network and the ROADM within the transport network may switch to a troubleshooting channel established by the router counterpart card associated with the ROADM.

In step 503, the network management system 103 may troubleshoot the error based on the generated test signal. By way of example, the network management system 103 may determine if the error is associated with the connection of the routing network to the transport network based on whether the test signal is successfully transmitted between the endpoint router and endpoint router counterpart card. If the test signal is successfully transmitted between the router and the router counterpart card, the network management system 103 may determine that the error is not associated with the connection between the routing network and the transport network and perform additional tests to pinpoint the cause of the error. If the test signal is not successfully transmitted, the network management system 103 may determine that the error is between the router and the router counterpart card and execute the necessary procedures to correct the error, such as dispatching crews to correct the error.

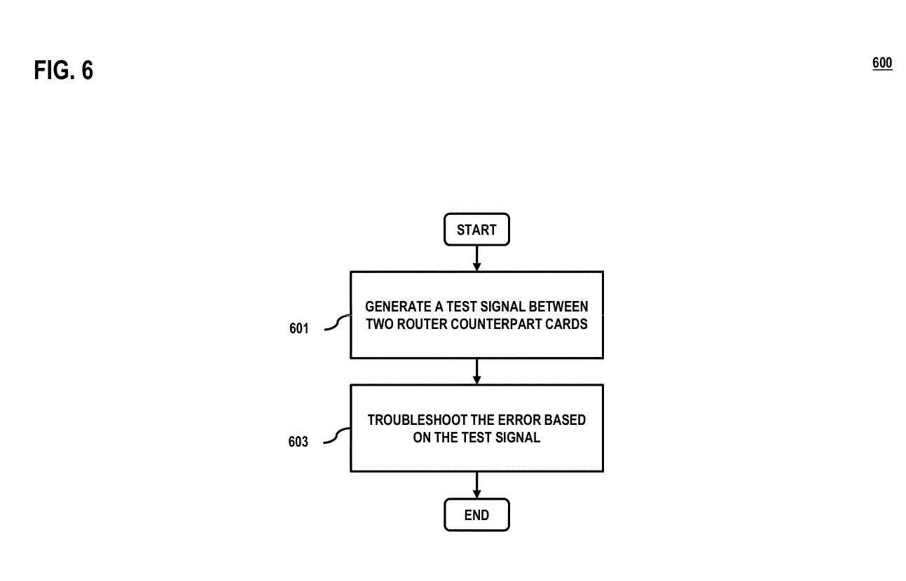

FIG. 6 is a flowchart of troubleshooting an error between two router counterpart cards, according to one embodiment. In one embodiment, one or more router counterpart cards as illustrated in FIG. 3A or 3B perform the process 600. In step 601, one of the two router counterpart cards may generate a test signal and transmit the test signal to the other router counterpart card within the transport network 101. The two router counterpart cards may be at either end of the transport network, may be in sequential order within the transport network, or any location in-between, as illustrated in FIGS. 2D and 2E.

In step 603, the network management system 103 may troubleshoot the error based on whether the transmitted test signals successfully reach their intended targets. Thus, for instance, the network management system 103 may cause the router counterpart cards at the egress and ingress of the transport network to transmit test signals to each other. Depending on whether the test signals reach the other router counterpart card, the network management system 103 may vary which router counterpart cards are used to transmit the test signals until the test signals indicate the section of the transport network at which the error is occurring. Upon determining the location, the service provider associated with the transport network may dispatch crews to correct the error as necessary.

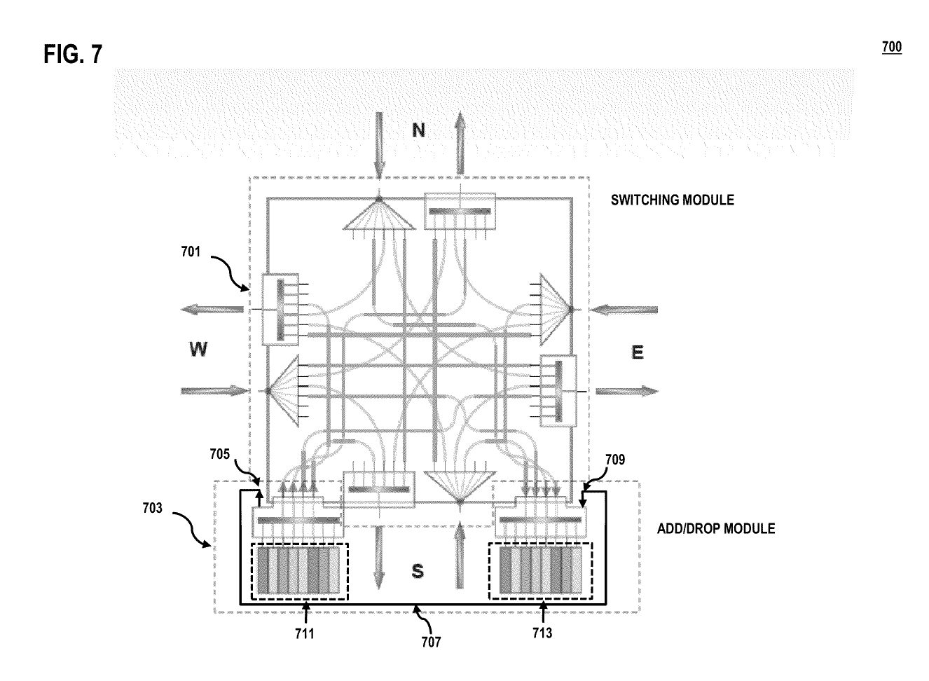

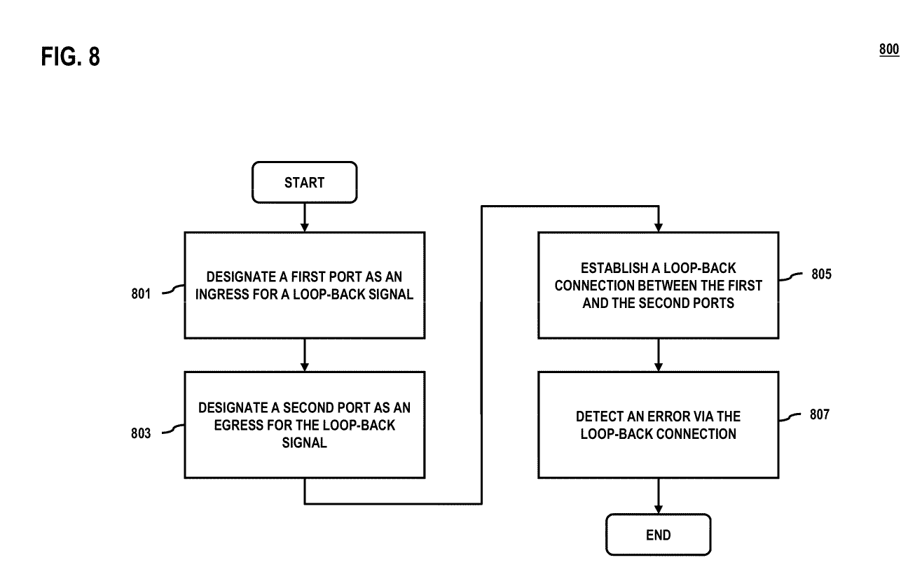

FIG. 7 is a diagram of a ROADM that can be deployed in the system of FIG. 1, according to one embodiment. The ROADM 700 may comprise one or more components configured to execute the described in, for example, FIG. 8, as detailed below, for providing the loop-back functionality of within the system 100. In one embodiment, the ROADM 700 includes a switching module 701 and an add/drop module 703. The switching module 701 is configured to switch signals to another optical communication node within the transport network 101 and the add/drop module 703 is configured to add and/or drop signals. The ROADM 700 contains a first port 705 designated as an ingress for a loop-back signal to be transported on a loop-back connection 707, and a second port 709 designated as an egress for the loop-back signal. In the exemplary ROADM 700, the first port 705 and the second port 709 are on the add/drop module 703. As illustrated, the ROADM is configured to enable loop-back functionality at any add ports 711 and any drop ports 713, and in any direction (e.g., North (N), South (S), West (W), and East (E)). While specific reference will be made to this particular embodiment, it is also contemplated that ROADM 700 may embody many forms and include multiple and/or alternative components. For example, it is contemplated that the components of ROADM 700 may be combined, located in separate structures, or separate locations. Additionally, the first port 705, loop-back connection 707, and the second port 709 may be located, for instance, on the switching module 701, add/drop module 705, or a combination thereof. It is contemplated the ROADM 700 may contain one or more first ports 705, one or more second ports 709, and one or more loop-back connections 707. Additionally, or alternatively, a transport network may contain one or more ROADMs 700 with loop-back functionality, and one or more ROADMs without loop-back functionality. The transport network may include ROADMs with or without loop-back connections 707 that also are and are not associated with router counterpart cards.

FIG. 8 is a flowchart of a process for troubleshooting an optical network with a ROADM in that includes a loop-back connection, according to one embodiment. For illustrative purposes, the process 800 is described with respect to the systems of FIGS. 1 and 7. It is noted that the steps of process 800 may be performed in any suitable order, as well as combined or separated in any suitable manner. By way of example, such process 800 is performed by ROADM-2.

In step 801, the process 800 designates a first port as an ingress for a loop-back signal to troubleshoot an error within a transport network. For example, one port on a switch (e.g., wavelength selective, photonic, multi-cast, etc.) or splitter (e.g., optical splitter, coupler, wavelength splitter, combiner, etc.) is associated (e.g., added, assigned, designated, etc.) with a loop-back signal to be transported back to a source. In one embodiment, the network management system 103 is able to control how to switch loop-back signals via the first port.

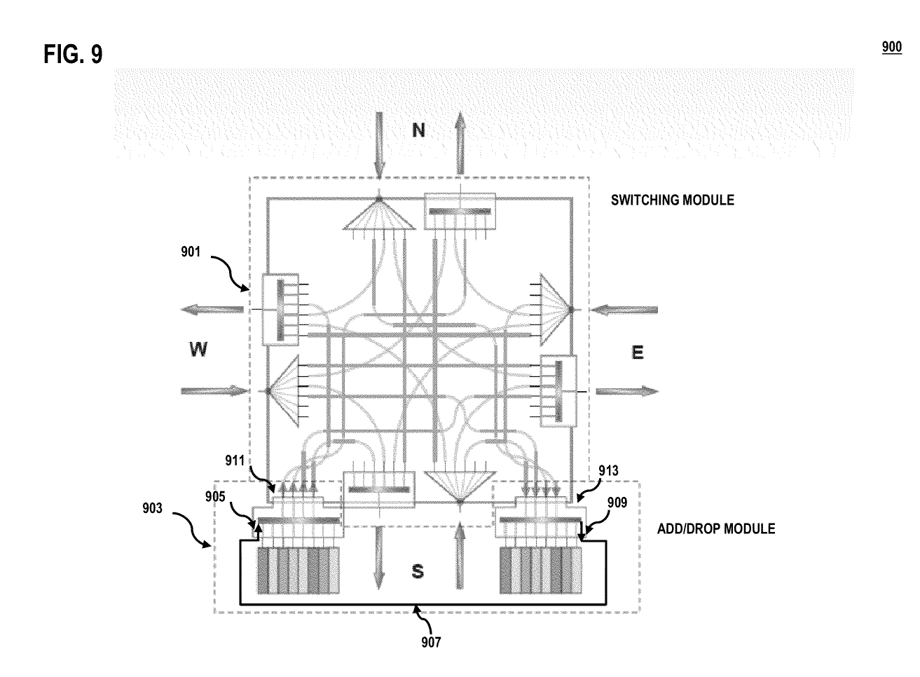

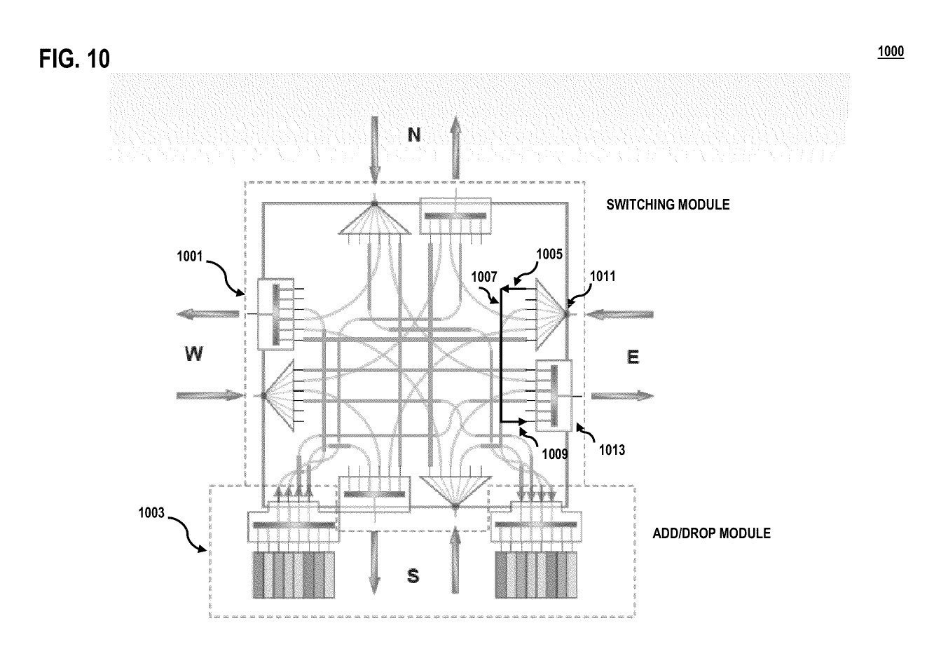

In step 803, the process 800 designates a second port as an egress for a loop-back signal to troubleshoot an error within the transport network. For instance, one output port on a switch (e.g., wavelength selective, photonic, multi-cast, etc.) or splitter (e.g., optical splitter, coupler, wavelength splitter, combiner, etc.) is associated with a loop-back signal to be transported back to a source. In one embodiment, the first port and the second port are located on the same module (e.g., add/drop module, switching module). Additionally, the loop-back functionality may be performed towards a routing network (e.g., customer equipment) or the transport network (e.g., network equipment). As used herein, loop-back functionality towards customer equipment refers to signals received (and sent) by the add/drop module, and loop-back functionality towards network equipment refers to signals received (and sent) by the switching module. For instance, the first port and the second port may be located on the add/drop module to loop-back signals towards network equipment (e.g., as illustrated in FIG. 9). In another example, the first port and the second port are located on the switching module to loop-back signals towards network equipment (e.g., as illustrated in FIG. 10). In yet another example, the first port and the second port are located on the add/drop module to loop-back signals towards customer equipment (e.g., as illustrated in FIGS. 7 and 11-13).

In step 805, process 800 establishes a loop-back connection between the first port and the second port to transport the loop-back optical signal. For example, the first port and the second port may be connected by a fiber optic cable, to transfer the loop-back optical signal from the first port to the second port.

Once the process 800 establishes the loop-back connection, the network management system 103 detects, as in step 807, an error associated with a portion of a transport network formed by nodes based on the loop-back signal. For instance, an error (e.g., failure, loss of connectivity, degradation of network performance, etc.) is further isolated by transferring a loop-back signal via the loop-back connection and monitoring the loop-back signal. That is, the network management system 103 switches a loop-back signal to the first port and selectively switches the loop-back signal from the second port to determine whether or not a path traveled by the loop-back signal contains a portion of the communication path causing the error. In this manner, loop-back functionality enables network operators to check and isolate problems (e.g., errors, failures, etc.) quickly and to clearly identify responsibility during network failure. In one embodiment, a loop-back signal is generated at another optical communication node within the transport network, and the loop-back connection receives the loop-back signal.

The processes described within respect to FIG. 8 may be combined within any one or more of the processes described above with respect to FIGS. 4-6 where the optical communication nodes include both router counterpart cards and loop-back connection. For instance, the process illustrated in FIG. 2D may be modified such that RCC-1 with ROADM-1 may send a test signal to the ROADM-3, which may include a loop-back connection. The ROADM-3 using the loop-back connection may then transmit the test signal back to the RCC-1. Thus, the same router counterpart card may be used to generate and receive a test signal to determine the location of an error within a transport network. Thus, any combination of optical communication nodes (e.g., ROADMs) within the transport network may include any combination of router counterpart cards and loop-back connections to determine the location of errors within the transport network, or errors between the connection of a transport network with a routing network.

FIG. 9 is a diagram of a ROADM 700 configured to check and isolate problems towards network equipment with loop-back ports located on the add/drop module, according to one embodiment. In the exemplary embodiment, the ROADM 700 contains a switching module 701, and an add/drop module 703. The add/drop module 703 includes a first port 705, a loop-back connection 707, and a second port 709. In the exemplary embodiment, the selection of signals into the first port 705 is performed on a per-wavelength basis by a wavelength selective switch 711 and the selection of signals from the second port 709 is performed on a per-wavelength basis by a wavelength selective switch 713.

FIG. 10 is a diagram of a ROADM configured to check and isolate problems towards network equipment with loop-back ports located on the switching module, according to one embodiment. In the exemplary embodiment, the ROADM 1000 contains a switching module 1001, and an add/drop module 1003. The switching module 1001 includes a first port 1005, a loop-back connection 1007, and a second port 1009. In the exemplary embodiment, the selection of signals into the first port 1005 is performed by an optical splitter 1011 and the selection of signals from the second port 1009 is performed by a wavelength selective switch 1013. It is contemplated, that the loop back function illustrated in FIG. 10, may be applied to other network directions (e.g., North, West, and South).

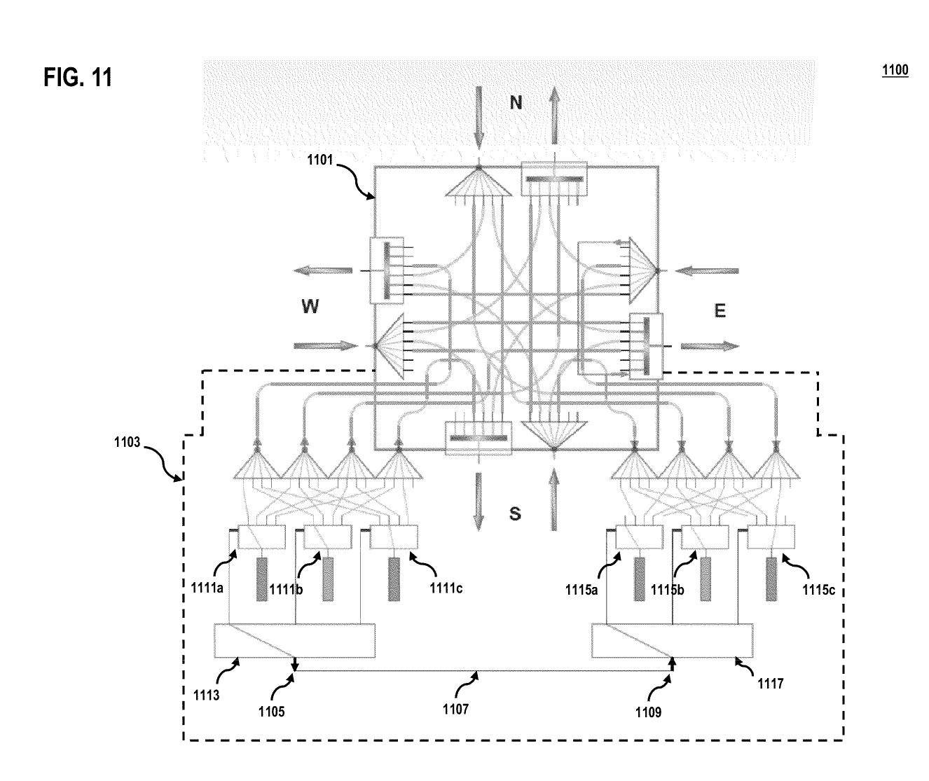

FIG. 11 is a diagram of a ROADM configured to check and isolate problems towards customer equipment with loop-back ports located on the add/drop module, according to one embodiment. In the exemplary embodiment, the ROADM 1100 contains a switching module 1101, and an add/drop module 1103. The add/drop module 1103 includes a first port 1105, a loop-back connection 1107, and a second port 1109. In the exemplary embodiment, the selection of signals into the first port 1105 is performed by photonic switch 1111 (e.g., photonic switch 1111a) and photonic switch 1113 and the selection of signals from the second port 1109 is performed by photonic switch 1115 (e.g., photonic switch 1115a) and photonic switch 1117.

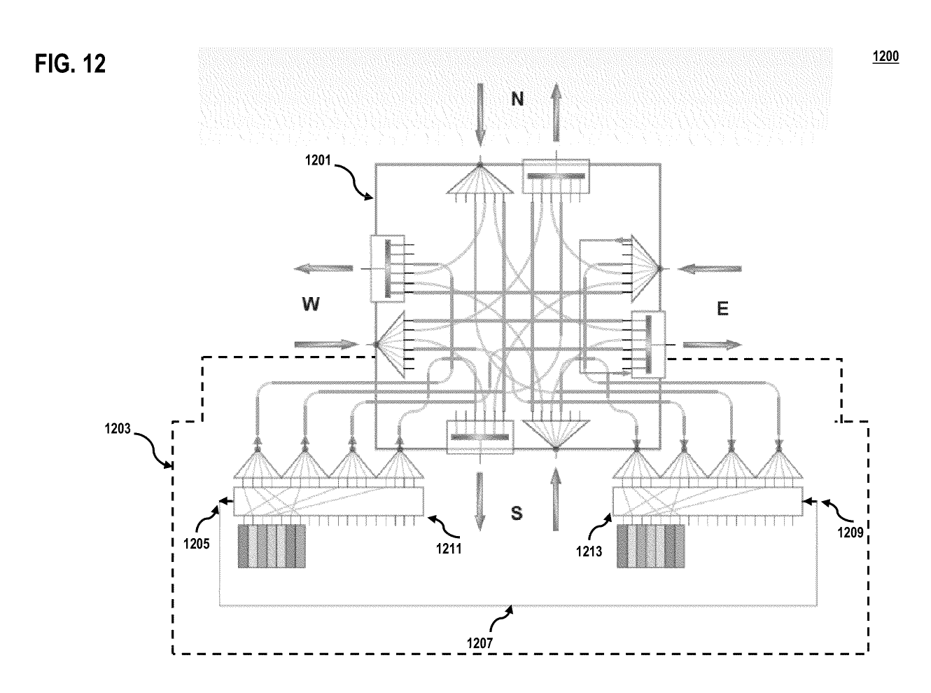

FIG. 12 is another diagram of a ROADM configured to check and isolate problems towards customer equipment with loop-back ports located on the add/drop module, according to one embodiment. In the exemplary embodiment, the ROADM 1200 contains a switching module 1201, and an add/drop module 1203. The add/drop module 1203 includes a first port 1205, a loop-back connection 1207, and a second port 1209. In the exemplary embodiment, the selection of signals into the first port 1205 is performed by photonic switch 1211 and the selection of signals from the second port 1209 is performed by photonic switch 1213.

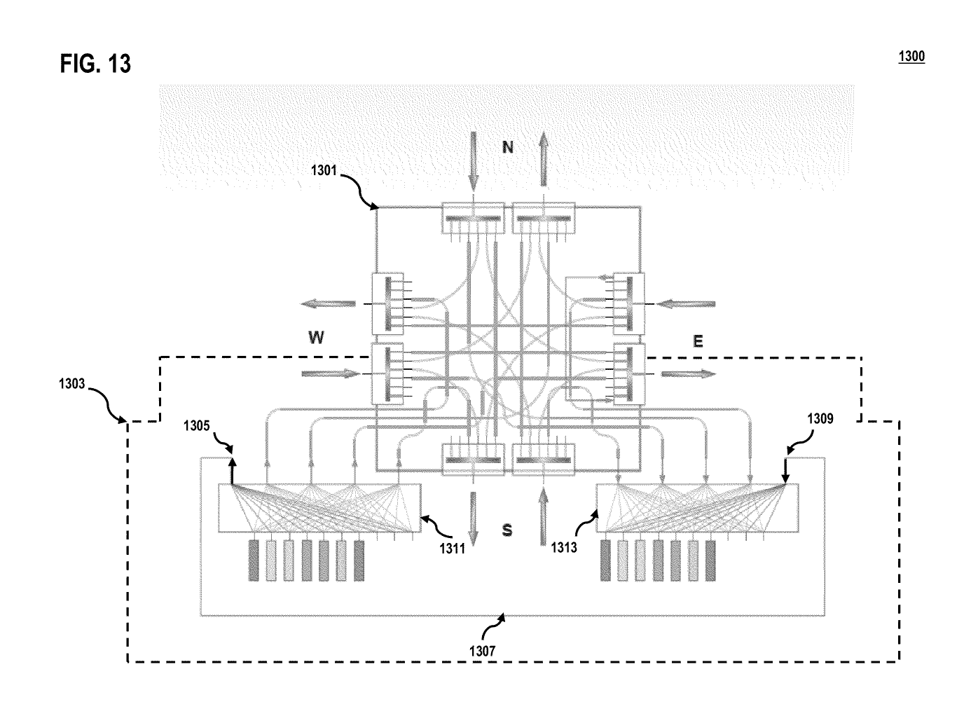

FIG. 13 is yet another diagram of a ROADM configured to check and isolate problems towards customer equipment with loop-back ports located on the add/drop module, according to one embodiment. In the exemplary embodiment, the ROADM 1300 contains a switching module 1301, and an add/drop module 1303. The add/drop module 1303 includes a first port 1305, a loop-back connection 1307, and a second port 1309. In the exemplary embodiment, the selection of signals into the first port 1305 is performed by multi-cast switch 1311 and the selection of signals from the second port 1309 is performed by multi-cast switch 1313.

The processes for troubleshooting ROADM networks described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

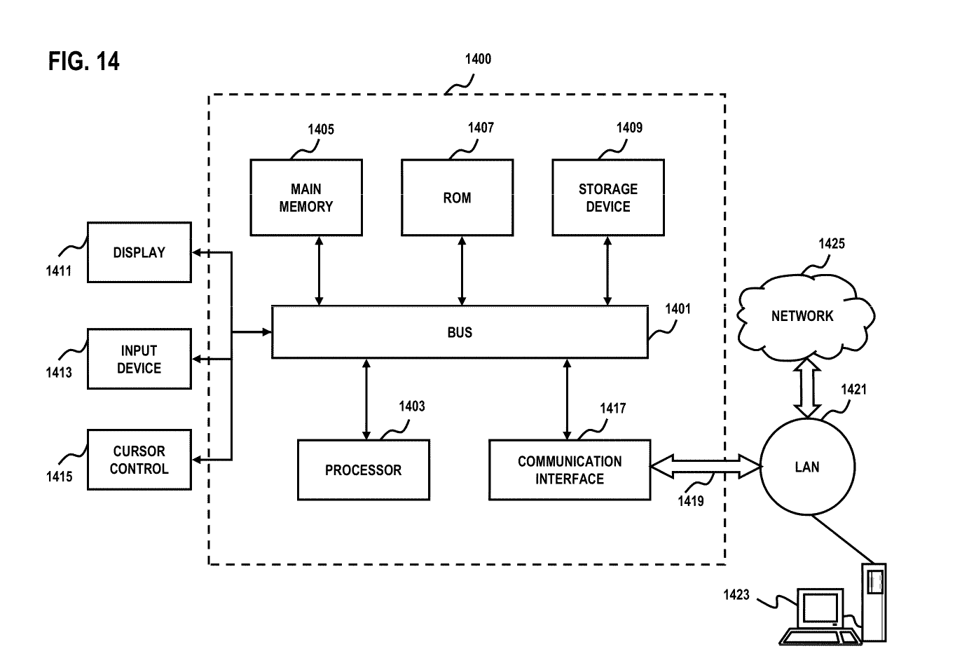

FIG. 14 illustrates computing hardware (e.g., computer system) upon which an functions associated with the processes described above can be implemented. The computer system 1400 includes a bus 1401 or other communication mechanism for communicating information and a processor 1403 coupled to the bus 1401 for processing information. The computer system 1400 also includes main memory 1405, such as random access memory (RAM) or other dynamic storage device, coupled to the bus 1401 for storing information and instructions to be executed by the processor 1403. Main memory 1405 also can be used for storing temporary variables or other intermediate information during execution of instructions by the processor 1403. The computer system 1400 may further include a read only memory (ROM) 1407 or other static storage device coupled to the bus 1401 for storing static information and instructions for the processor 1403. A storage device 1409, such as a magnetic disk or optical disk, is coupled to the bus 1401 for persistently storing information and instructions.

The computer system 1400 may be coupled via the bus 1401 to a display 1411, such as a cathode ray tube (CRT), liquid crystal display, active matrix display, or plasma display, for displaying information to a computer user. An input device 1413, such as a keyboard including alphanumeric and other keys, is coupled to the bus 1401 for communicating information and command selections to the processor 1403. Another type of user input device is a cursor control 1415, such as a mouse, a trackball, or cursor direction keys, for communicating direction information and command selections to the processor 1403 and for controlling cursor movement on the display 1411.

According to an embodiment of the invention, the processes described herein may be performed by the computer system 1400, in response to the processor 1403 executing an arrangement of instructions contained in main memory 1405. Such instructions can be read into main memory 1405 from another computer-readable medium, such as the storage device 1409. Execution of the arrangement of instructions contained in main memory 1405 causes the processor 1403 to perform the process steps described herein. One or more processors in a multi-processing arrangement may also be employed to execute the instructions contained in main memory 1405. In alternative embodiments, hard-wired circuitry may be used in place of or in combination with software instructions to implement the embodiment of the invention. Thus, embodiments of the invention are not limited to any specific combination of hardware circuitry and software.

The computer system 1400 also includes a communication interface 1417 coupled to bus 1401. The communication interface 1417 provides a two-way data communication coupling to a network link 1419 connected to a local network 1421. For example, the communication interface 1417 may be a digital subscriber line (DSL) card or modem, an integrated services digital network (ISDN) card, a cable modem, a telephone modem, or any other communication interface to provide a data communication connection to a corresponding type of communication line. As another example, communication interface 1417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1417 sends and receives electrical, electromagnetic, or optical signals that carry digital data streams representing various types of information. Further, the communication interface 1417 can include peripheral interface devices, such as a Universal Serial Bus (USB) interface, a PCMCIA (Personal Computer Memory Card International Association) interface, etc. Although a single communication interface 1417 is depicted in FIG. 14, multiple communication interfaces can also be employed.

The network link 1419 typically provides data communication through one or more networks to other data devices. For example, the network link 1419 may provide a connection through local network 1421 to a host computer 1423, which has connectivity to a network 1425 (e.g. a wide area network (WAN) or the global packet data communication network now commonly referred to as the “Internet”) or to data equipment operated by a service provider. The local network 1421 and the network 1425 both use electrical, electromagnetic, or optical signals to convey information and instructions. The signals through the various networks and the signals on the network link 1419 and through the communication interface 1417, which communicate digital data with the computer system 1400, are exemplary forms of carrier waves bearing the information and instructions.

The computer system 1400 can send messages and receive data, including program code, through the network(s), the network link 1419, and the communication interface 1417. In the Internet example, a server (not shown) might transmit requested code belonging to an application program for implementing an embodiment of the invention through the network 1425, the local network 1421 and the communication interface 1417. The processor 1403 may execute the transmitted code while being received and/or store the code in the storage device 1409, or other non-volatile storage for later execution. In this manner, the computer system 1400 may obtain application code in the form of a carrier wave.

The term “computer-readable medium” as used herein refers to any medium that participates in providing instructions to the processor 1403 for execution. Such a medium may take many forms, including but not limited to non-volatile media, volatile media, and transmission media. Non-volatile media include, for example, optical or magnetic disks, such as the storage device 1409. Volatile media include dynamic memory, such as main memory 1405. Transmission media include coaxial cables, copper wire and fiber optics, including the wires that comprise the bus 1401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

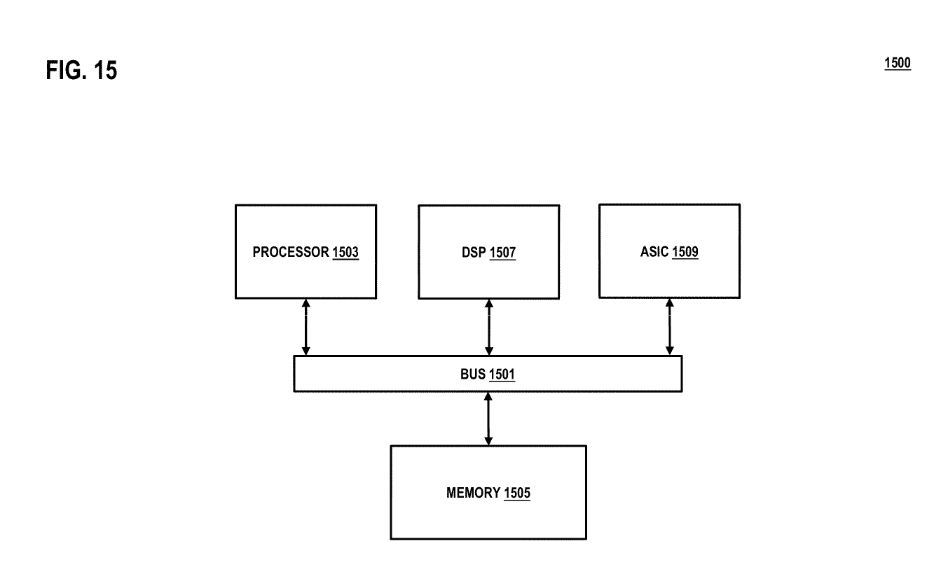

FIG. 15 illustrates a chip set 1500 upon which processes of the invention may be implemented. Chip set 1500 is programmed to present a slideshow as described herein and includes, for instance, the processor and memory components described with respect to FIG. 14 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1500, or a portion thereof, constitutes a means for performing one or more steps of FIGS. 4-6 and 8.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1503 and accompanying components have connectivity to the memory 1505 via the bus 1501. The memory 1505 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1505 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
detecting an error associated with a routing network coupled to a transport network comprising a plurality of optical communication nodes;
switching, by an optical communication node, to a troubleshooting channel associated with the transport network using one or more router counterpart cards; and
troubleshooting the error using the one or more router counterpart cards.

2. A method according to claim 1, further comprising:
generating a test signal between the routing network and a router counterpart card; and
troubleshooting the error based on the test signal,
wherein the router counterpart card is a shared demarcation point within the transport network.

3. A method according to claim 2, wherein the test signal is generated by the router counterpart card, a node on the routing network, or a combination thereof.

4. A method according to claim 1, further comprising:
generating a test signal between two router counterpart cards; and
troubleshooting the error based on the test signal.

5. A method according to claim 4, wherein the two router counterpart cards are sequentially arranged along the transport network.

6. A method according to claim 1, wherein the optical communication nodes include a reconfigurable optical add/drop module.

7. A method according to claim 1, wherein the transport network includes a fiber optic network.

8. A system comprising:
a management platform; and
a plurality of optical communication nodes forming a transport network coupled to a routing network,
wherein the management platform is configured to detect an error associated with the transport network, instruct an optical communication node to switch to a troubleshooting channel associated with the transport network using one or more router counterpart cards, and troubleshoot the error using the one or more router counterpart cards.

9. A system according to claim 8, wherein the management platform is configured to cause a generation of a test signal between the routing network and a router counterpart card, and troubleshoot the error based on the test signal.

10. A system according to claim 8, wherein the router counterpart card, a communication node on the routing network, or a combination thereof generate the test signal.

11. A system according to claim 8, wherein a first router counterpart card is configured to generate a test signal between the first router counterpart card and a second router counterpart card, and the management platform is configured to troubleshoot the error based on the test signal.

12. A system according to claim 11, wherein the first router counterpart card and the second router counterpart card are sequentially arranged along the transport network.

13. A system according to claim 8, wherein the optical communication nodes include a reconfigurable optical add/drop module.

14. A system according to claim 8, wherein the transport network includes a fiber optic network.

15. A system according to claim 8, wherein the one or more router counterpart cards include a multi-rate optical transmitter and a multi-rate optical receiver.

16. A system according to claim 8, wherein the one or more router counterpart cards include two or more optical transmitters of varying transmission rates.

17. A system according to claim 8, wherein the plurality of optical communication nodes include loop-back modules.

18. A system according to claim 8, wherein endpoint optical communication nodes at an egress and ingress of the transport network include the one or more router counterpart cards, and non-endpoint optical communication nodes include the loop-back module.

19. A system according to claim 18, wherein the optical communication module is a reconfigurable optical add/drop module and the loop-back module is applied to an add/drop module.

20. A system according to claim 18, wherein the loop-back module is applied to a network direction of the optical communication node.
